(19) United States
(12) Patent Application Publication
(10) Pub. No.: US 2023/0286794 A1
(43) Pub. Date: Sep. 14, 2023

(54) Foil Cutter

(71) Applicant: COUNTRY ENTERPRISES, INC., Lucan, MN (US)

(72) Inventors: Cory R. Jensen, Lucan, MN (US); Jason P. Geurts, Marshall, MN (US); Josh R. Fogelson, Vesta, MN (US)

(21) Appl. No.: 18/181,516

(22) Filed: Mar. 9, 2023

Related U.S. Application Data
(60) Provisional application No. 63/318,383, filed on Mar. 9, 2022.

(51) Int. Cl. B67B 7/46

(52) U.S. Cl. CPC B67B 7/30

(57) ABSTRACT

A foil cutter has a unitary container engaging sleeve, a unitary foil cutter assembly, and a cutting blade retained therebetween. The container engaging sleeve has a cylindrical outer shell, a container opening receiving cavity, a lip configured to contact with a container affixed foil seal, and a blade retainer. The foil cutter assembly has a body that is inserted within the outer shell, and a cutting blade retainer. The cutting blade is extends from the foil cutter assembly, but is recessed within the container engaging sleeve to prevent accidental contact. The foil cutter is operably pressed onto a receptacle opening sealed by an affixed foil seal, and then rotated to pierce, remove, and retain the foil seal. A seal pusher has geometry complementary to the foil cutter assembly, and inserts longitudinally through to discharge foil seals that have been separated from containers, preferably into an empty container.

### CROSS REFERENCE TO RELATED APPLICATIONS

The present application claims the benefit of U.S. provisional patent application 63/318,383 filed Mar. 9, 2022 of like title and inventorship, the teachings and entire contents which are incorporated herein by reference.

### BACKGROUND OF THE INVENTION

### 1. Field of the Invention

The present invention pertains generally to hand tools, and more particularly to a receptacle closure remover configured to remove a destructible and anti-tampering seal applied to containers having a narrowing necked portion. In a preferred manifestation, the receptacle closure remover has both an impaling member and a cutter.

### 2. Description of the Related Art

When it comes to saving time, tools that allow an operator to go from task to task rapidly, while also providing for simple and error free operation, can make the task easier, safer, and cleaner or more sanitary.

One particularly challenging task is opening containers that have a destructible and anti-tampering seal applied to the narrowed necked portion of the container. These seals are often referred to as foil seals, whether or not they actually contain any metal, since they often comprise either a metal foil or a metal foil and plastic laminate that has been welded or otherwise affixed to the opening or pour spout of the container. With appropriate materials and construction, these seals provides a leak free closure that is visibly damaged in the event of tampering or damage during shipping and handling.

Unfortunately, these very same properties that ensure a safe and secure closure also make the seal very difficult to remove from the container quickly and accurately. Common tools used to open these container seals are pocket knives, screwdrivers, and any other small and generally pointy or sharp instruments. If the container is being opened at an altitude or temperature significantly greater than the altitude or temperature that the container was sealed at, the container may be pressurized and prone to spraying or splashing when the seal is broken. Similarly, if the person inadvertently squeezes the container while opening, such as by grasping the container too tightly, the container will also be prone to spraying or splashing.

Even when the closure is punctured or peeled with great care, all too often a thin membrane of plastic remains adhered to all or a substantial proportion of the container opening. Sometimes the entirety of the foil top peels from another lamina or layer of the seal, leaving the container unopened. Other times, the foil seal is punctured but still at least partially blocks the opening, thereby interfering with smooth flow of the contents when emptying of the container which in turn can lead to undesirable spilling. In addition, if a small portion or shred of the seal tears apart during opening this small portion can end up in the container contents during dispensing, potentially causing harm to equipment.

To resolve these problems a person may need to use a knife to finish fully removing the container top. Nevertheless, much care has to be taken to: avoid cutting one's self while cutting the seal; completely remove the seal without consequentially damaging the container neck; avoid splashing, spilling, or squeezing the container enough to accidentally discharge at least some of the contents; avoid contact with any contents residue that may remain on the seal, including until the seal has been disposed of safely; avoid dropping the seal or some fragment of the seal into the container after cutting the foil top open; and avoid introducing contaminants into the container during or immediately subsequent to seal removal.

Recognizing the challenges created by these seals, some artisans have devised bottle lids that incorporate blades right into or as part of the bottle lid. Exemplary U.S. patents and published applications, the teachings which are incorporated herein by reference, include: U.S. Pat. No. 4,340,147 by McIntosh, entitled “Cap with built in piercing device”; U.S. Pat. No. 5,090,582 by Art et al, entitled “Bottle cap”; U.S. Pat. No. 5,148,937 by Huard, entitled “Cap with perforating spike for container with protective membrane”; U.S. Pat. No. 8,079,485 by Brendt, entitled “Closure with perforating feature for container seals”; U.S. Pat. No. 8,616,090 by Ferraro, entitled “Bottle seal breaker”; U.S. Pat. No. 8,893,912 by Van Der Molen et al, entitled “Closure device”; U.S. Pat. No. 9,834,346 by Ferraro, entitled “Adaptable bottle seal breaker cap”; and 2004/0099686 by Rho, entitled “Cutting apparatus of sealed beverage vessel”.

All of these provide a container top with a method for removing seal on the bottle. Unfortunately, they do not have a retaining mechanism to prevent the cut foil from falling back into the container. Further, in some of these inventions the incorporation of a blade into the bottle lid: increases the likelihood that the seal will be accidentally ruptured prior to the intended use; undesirably increases the expense of the container; and complicates recycling of the container lid. The risk of accidental rupture will of course decrease yield of useful product and so thereby increases overall expense. Nevertheless, such rupture can be more consequential than just out-of-pocket expense, particularly when the chemicals contained within the containers are hazardous or particularly messy. Examples of such chemicals, though not limiting the present invention thereto, include herbicides and other agricultural chemicals, and machine chemicals including but not limited to motor oil and anti-freeze. Lastly, the type of cutter or blade incorporated into the lid is commonly of the same material as the lid, such as plastic, that provides a poor cutting edge. When the cutter is poor, there is a very high likelihood of the cutter leaving a rough perimeter around the bottle opening that can lead to an irregular pour pattern, often resulting in accidental spilling of some of the contents during pouring or dispensing, even when the contents are very carefully poured from the container.

Some artisans have devised cutting blades that are designed to cut the seal off of the bottle, and the teeth are shaped or configured to also retain the seal. Exemplary U.S. and Foreign patents and published applications, the teachings which are incorporated herein by reference, include: U.S. Pat. No. 1,789,729 by Coyle, entitled “Can-end-cutting device”; U.S. Pat. No. 4,185,756 by Sciamonte, entitled “Dispensing package and method”; U.S. Pat. No. 5,082,136 by Schumann, entitled “Container and cap construction”; U.S. Pat. No. 5,709,311 by Butler et al, entitled “Method and apparatus for removing and storing a container seal”; U.S. Pat. No. 6,386,385 by Amanat et al, entitled “Methods and apparatus for removing tamper-proof seals from containers”; 2005/0173436 by Amant et al., entitled “Methods and apparatus for removing tamper-evident seals from containers”; DE8410951U1 by Riewesell, entitled “Closing cap for container”; EP0678455A1 by Cimarelli et al, entitled “Closure device for easy-open container”; EP1234778A1 by Bonifacio et al, entitled “Pierce and cut closure”; GB2305655A by Clark, entitled “Device or closure for cutting a container seal membrane”; and WO9324405A1 by Rigby et al, entitled “Tool for opening a container”.

While the seal retention is of significant benefit, these aforementioned patents and published applications still incorporate a blade into the bottle lid, and thereby suffer from the aforementioned deficiencies including: increased likelihood that the seal will be accidentally ruptured prior to the intended use; undesirably increased expense of the container; complicated recycling of the container lid; and a poor cutting edge.

Other artisans have devised external cutters that are designed to cut the seal off of the bottle, and also provide a separate seal retainer. Exemplary U.S. and Foreign patents and published applications, the teachings which are incorporated herein by reference, include: U.S. Pat. No. 521,643 by Dallas, entitled “Can opener”; U.S. Pat. No. 3,581,605 by Taylor, entitled “Opening device for membrane-sealed plastic bottles”; U.S. Pat. No. 6,089,391 by Abelbeck et al, entitled “Container cap and system”; U.S. Pat. No. 8,820,554 by Rho, entitled “Vessel cap having a cutter and hook for removing and retaining a seal”; 2008/0164234 by Rho, entitled “Child-Resistant Cap”; 2009/0301988 by Rho, entitled “Vessel cap and system for manufacturing the same”; 2010/0000996 by Rho, entitled “Closure of vessel and process for manufacturing same”; and 2013/0291441 by Rho, entitled “Sealing member for vessel”; DE523569C by Lafarge, entitled “Hole punch and opener designed as an airtight stopper for cans or similar containers”; DE29823598U1 by Wallrath, entitled “Lid Operators for Round Containers”; FR2222305A1 by Ragaine, entitled “Manual safety-type can opener”; and JPS5697249U by Taito, entitled “Raise-type opening cap”.

Once again, while the seal retention is of significant benefit, these aforementioned patents and published applications still incorporate a blade into a unitary structure similar to or identical to the bottle lid. They are prone to provide a poor or sub-par cutting edge, and with a poor cutting edge are more likely to strip the threads of either or both of the cutter or the receptacle or container. In addition, while the seal is retained on the seal cutter, the lack of good apparatus for removing the seal from the retainer either means the seal cutter and retainer will only be used once, or a person will need to improvise such as by manually grasping the seal to remove it from the retainer. Particularly in the case of hazardous or messy contents, the separated seal affixed to a seal retainer is nearly as much of a problem to deal with as the intact seal.

Yet other artisans have devised separate seal cutters configured to facilitate the opening of containers. Exemplary U.S. and Foreign patents and published applications, the teachings which are incorporated herein by reference, include: U.S. Pat. No. 213,723 by Wilson, entitled “Can-opener”; U.S. Pat. No. 1,024,403 by Hill, entitled “Bottle opener”; U.S. Pat. No. 1,048,202 by Oberg, entitled “Can opening device”; U.S. Pat. No. 2,176,714 by Hoppenstand, entitled “Container opener”; U.S. Pat. No. 2,648,128 by Tanking, Jr., entitled “Can opener”; U.S. Pat. No. 5,388,297 by Ross, entitled “Container opening tool”; U.S. Pat. No. 10,906,792 by Karras, entitled “Can piercing tool”; GB2071600A by Gregson et al, entitled “Container-cutting device”; and GB2098166A by Eng, entitled “Tin opener”.

While the inventions disclosed by these artisans in these patents and published applications enable a manufacturer to provide enhanced, much sharper cutters, they also fail to provide: both a seal retention apparatus and an apparatus to eject the seal without having to touch or otherwise contact the seal; and adequate blade protection. As noted herein above, there are a large number of industrial, agricultural, commercial, and even a few consumer products that either cannot or should not be touched. In addition, with higher quality blades comes a substantially increased risk of harm in the event of human contact therewith. Consequently, if sharper cutters are being provided by a manufacturer, it is also highly desirable that they be provided with sufficient structure to protect a person from inadvertent contact therewith. Once again, this is particularly important with hazardous container contents, since even if a person is wearing adequate safety gear such as rubber or other suitable gloves, contact with a sharp cutter blade can break the protective barrier provided by such safety gear.

One particular artisan has overcome each of the aforementioned deficiencies of the prior art, and so has designed a much more universally beneficial seal cutter. In U.S. Pat. No. 4,074,426 by Brandt, entitled “Threaded blade holder”, the teachings which are incorporated herein by reference, a blade is illustrated that cuts a diaphragm while a spike retains the cut piece. Subsequent to one or more diaphragms being cut, ejection of the severed diaphragm(s) is achieved by withdrawing the spike from the blade holder. The blade is described as being inserted into an opening, and held therein by a detent engaging with an aperture in the blade. While a substantial improvement over the prior art incorporated by reference herein above, the Brandt blade must flex to be inserted and removed, and therefore requires significant, undesirable force for insertion and removal. Noteworthy is that, if the force required for blade removal and replacement is low, the blade risks becoming dislodged during use. Yet an application of a larger force for insertion and removal of a very sharp blade is also quite undesirable and can lead to serious injury. In practice, ordinary manufacturing tolerances can lead to a very wide swing in the amount of insertion and retention force generated, since small changes in the flexure distance will lead to very large changes in the amount of required insertion and removal force applied. Similarly, any damage to the detent or blade opening can drastically change the insertion and removal forces. In addition, while the spike is configured to release the cut diaphragm material, in the event the cut diaphragm portion wrinkles or folds, the diaphragm may engage at least in part with the inner wall of the threaded bore. In such case, removal of the spike may in fact lead to a wedging of the cut diaphragm, necessitating either undesirable handling of the diaphragm to remove it or additional and time-consuming manipulation with the spike.

As may be apparent then, in spite of the enormous advancements and substantial research and development that has been conducted, there still remains a need for an improved foil cutter configured to facilitate removal of at least a portion of a seal from a receptacle or container to leave behind a clean and smooth dispensing edge, without contaminating the container contents and while avoiding manual contact with the cutter, the seal, or the receptacle contents.

In addition to the foregoing patents, Webster's New Universal Unabridged Dictionary, Second Edition copyright 1983, is incorporated herein by reference in entirety for the definitions of words and terms used herein.

### SUMMARY OF THE INVENTION

In a first manifestation, the invention is, in combination, a container and a foil cutter. The container comprises a receptacle holding contents therein; an opening extending between the receptacle and an exterior of the receptacle; and an affixed foil seal closing the opening. The foil cutter comprises: a unitary container engaging sleeve having an outer shell, a container top receiving cavity encompassing the container opening and the affixed foil seal, and a blade retainer defined on an interior of the outer shell; a unitary foil cutter assembly having a body defining an interior and an exterior, the body inserted within the outer shell, a cutting blade retainer defined on an exterior of the body; and a cutting blade retained between the cutting blade retainer and the container engaging sleeve blade retainer, the cutting blade piercing the affixed foil seal.

In a second manifestation, the invention is, in combination, a container and a foil cutter. The container comprises a receptacle holding contents therein; an opening extending between the receptacle and an exterior of the receptacle; and an affixed foil seal closing the opening. The foil cutter comprises: a unitary container engaging sleeve having a cylindrical outer shell, a cylindrical container top receiving cavity defining a bottle top receiving opening encompassing the container opening and the affixed foil seal, a container engaging lip having an interior diameter smaller than a diameter of the container top receiving cavity, the container engaging lip in contact with the affixed foil seal, and a blade retainer defined on an interior of the outer shell; a unitary foil cutter assembly having a body defining an interior and an exterior, the body inserted within the outer shell, a sleeve stop terminating the body and engaging and affixed with a first longitudinal end of the cylindrical outer shell, and a cutting blade retainer defined on an exterior of the body; and a cutting blade retained between the cutting blade retainer and the container engaging sleeve blade retainer, the cutting blade piercing the affixed foil seal.

In a third manifestation, the invention is a foil cutter. The foil cutter comprises a container engaging sleeve having an outer shell, a container opening receiving cavity configured to encompass a container opening having an affixed foil seal, a container engaging lip having an interior opening smaller than an interior opening of the container top receiving cavity, the container engaging lip configured to contact with the affixed foil seal, and a blade retainer defined on an interior of the outer shell. The foil cutter additionally comprises a foil cutter assembly having a body defining an interior and an exterior, the body inserted within the outer shell, and a cutting blade retainer defined on an exterior of the body. The foil cutter further comprises a cutting blade retained between the cutting blade retainer and the container engaging sleeve blade retainer, the cutting blade configured to pierce the affixed foil seal.

### OBJECTS OF THE INVENTION

Exemplary embodiments of the present invention solve inadequacies of the prior art by providing a foil cutter having a unitary container engaging sleeve, a unitary foil cutter assembly, and a cutting blade retained between the unitary container engaging sleeve and unitary foil cutter assembly. The unitary container engaging sleeve has an outer shell, a container opening receiving cavity, a container engaging lip configured to contact with a container affixed foil seal, and a blade retainer defined on an interior of the outer shell. The unitary foil cutter assembly has a body that is inserted within the outer shell. A cutting blade retainer is defined on an exterior of the body. A cutting blade is retained between the cutting blade retainer and the container engaging sleeve blade retainer, and is configured to pierce an affixed foil seal.

The present invention and the preferred and alternative embodiments have been developed with a number of objectives in mind. While not all of these objectives are found in every embodiment, these objectives nevertheless provide a sense of the general intent and the many possible benefits that are available from embodiments of the present invention.

A first object of the invention is to provide an improved foil cutter configured to facilitate seal removal from a receptacle. A second object of the invention is to provide a very sharp and durable blade suitable for many repeated uses, of material different from the material of the receptacle, and configured leave a smooth perimeter around the bottle opening and configured to not tear the seal or generate small seal fragments. Another object of the present invention is to install the blade, and in some embodiments replace the blade, without application of dangerous or consequential forces to the blade. A further object of the present invention is to provide sufficient structure around the blade to protect a person from inadvertent contact with the blade without consequential interference with the aforementioned seal removal. Yet another object of the present invention is to selectively retain the entire removed seal material within the improved foil cutter. As a corollary thereto, the retaining mechanism will preferably prevent the cut foil from falling back into the container, and the cutter will cut the foil without generating fragments that might otherwise drop into the container. An additional object of the present invention is to selectively and reliably eject cut foil from the retaining mechanism. A further object of the invention is to enable a person to reliably and repeatedly open a foil seal while avoiding splashing, spilling, or squeezing the container enough to accidentally discharge at least some of the contents. As a corollary thereto, the foil cutter will preferably allow a person to avoid contact with any contents residue that may remain on the seal, including until the seal has been disposed of safely. Preferred embodiments of the invention are reusable, and are stored independent of a receptacle or container to eliminate any chance that the seal will be accidentally ruptured prior to the intended use, and to lower the cost of each container.

### BRIEF DESCRIPTION OF THE DRAWINGS

The foregoing and other objects, advantages, and novel features of the present invention can be understood and appreciated by reference to the following detailed description of the invention, taken in conjunction with the accompanying drawings, in which:

FIG. 1 illustrates a preferred embodiment foil cutter designed in accord with the teachings of the present invention from a front and slightly projected view.

FIGS. 2-4 illustrate a preferred embodiment seal cutter assembly used within the preferred embodiment foil cutter of FIG. 1 from a bottom plan view, top plan view, and front and slightly projected view, respectively.

FIG. 5 illustrates a preferred embodiment container engaging sleeve used within the preferred embodiment foil cutter of FIG. 1 from a front and slightly projected view.

FIGS. 6-7 illustrate a preferred embodiment seal pusher used in combination with the preferred embodiment foil cutter of FIG. 1, from a bottom and slightly projected view, and bottom plan view, respectively.

FIG. 8 illustrates the preferred embodiment seal pusher of FIGS. 6 and 7 used in combination with the preferred embodiment foil cutter of FIG. 1, with the container engaging sleeve removed only for purposes of illustration, from a side elevational view.

FIG. 9 illustrates a first alternative embodiment foil cutter designed in accord with the teachings of the present invention from a front and slightly projected view.

FIG. 10 illustrates a second alternative embodiment foil cutter designed in accord with the teachings of the present invention from a side elevational view.

### DESCRIPTION OF THE PREFERRED EMBODIMENT

Manifested in the preferred embodiment, the present invention provides a foil cutter that is configured to facilitate seal removal from a receptacle or container. For the purposes of the present disclosure, a foil seal is defined as a thin sheet or leaf of suitable material that closes a container or other receptacle or the like, irrespective of the seal material. Consequently, a foil seal as described herein explicitly includes: seals fabricated entirely from a metal foil; seals fabricated entirely from a plastic sheet; seals comprising a laminate of different materials; and seals fabricated from other composite or composition seal materials.

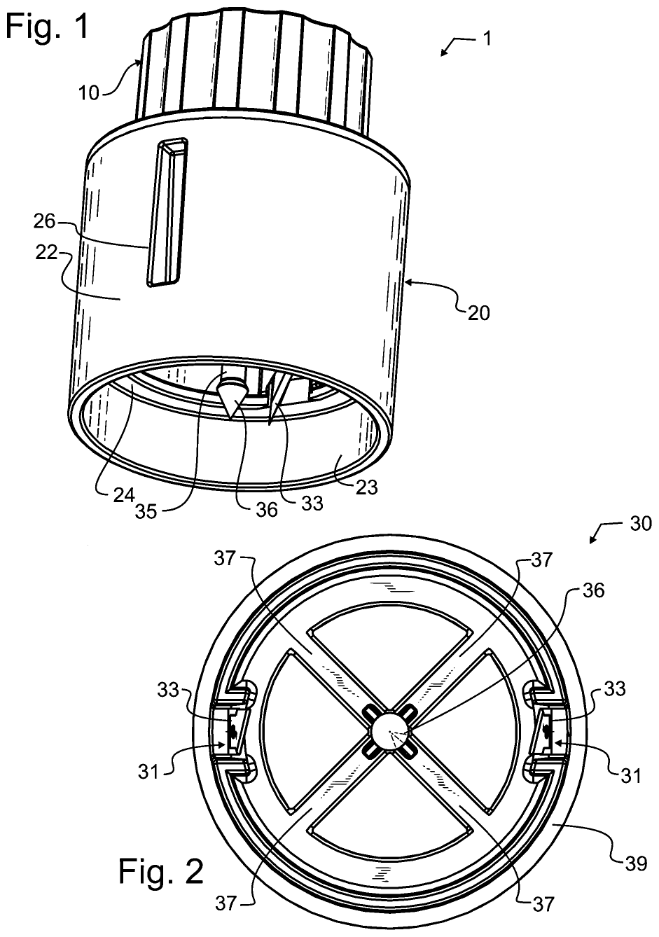

In a preferred embodiment of the invention illustrated in FIG. 1, a foil cutter 1 is comprised of a handle 10, a unitary bottle engaging sleeve 20, and a unitary foil cutter assembly 30. As may be appreciated, the geometry and location of handle 10 within foil cutter 1 is not critical to the present invention, so long as handle 10 facilitates good manual engagement to enable the requisite handling, engagement with, and rotation of foil cutter 1 relative to a container. While bottle engaging sleeve 20 and foil cutter assembly 30 are preferably unitary, in some alternative embodiments one or both of these components are manufactured from a plurality of components.

Container engaging sleeve 20 has an outer shell 22 that surrounds and isolates otherwise dangerous components of foil cutter assembly 30. Defining an open end of container engaging sleeve 20 is a container top receiving cavity 23. In preferred embodiment foil cutter 1, container top receiving cavity 23 is cylindrical, has smooth walls, and has a diameter dimensioned to accommodate externally or internally threaded container tops and other container geometries. In alternative embodiments, container top receiving cavity 23 will be provided with threading configured to engage with particular containers. In yet other alternative embodiments, container top receiving cavity 23 will be provided with other geometries configured to engage with particular containers.

In preferred embodiment foil cutter 1, a container engaging lip 24 is located interior of and preferably defines the end of container top receiving cavity 23. Container engaging lip 24 preferably has an interior diameter smaller than the interior diameter of container top receiving cavity 23. When ideally configured, during use container top receiving cavity 23 will be placed in circumscribing relationship about a container top having an affixed seal. The container seal will preferably rest or be pressed into contact with container engaging lip 24, thereby precisely locating the container top and container seal relative to preferred embodiment foil cutter 1. Preferably, both container top receiving cavity 23 and container engaging lip 24 will rotate freely about the container top and container seal, as will become apparent herein below. A blade retaining indent 26 will optionally be provided, the function which will also become apparent herein below.

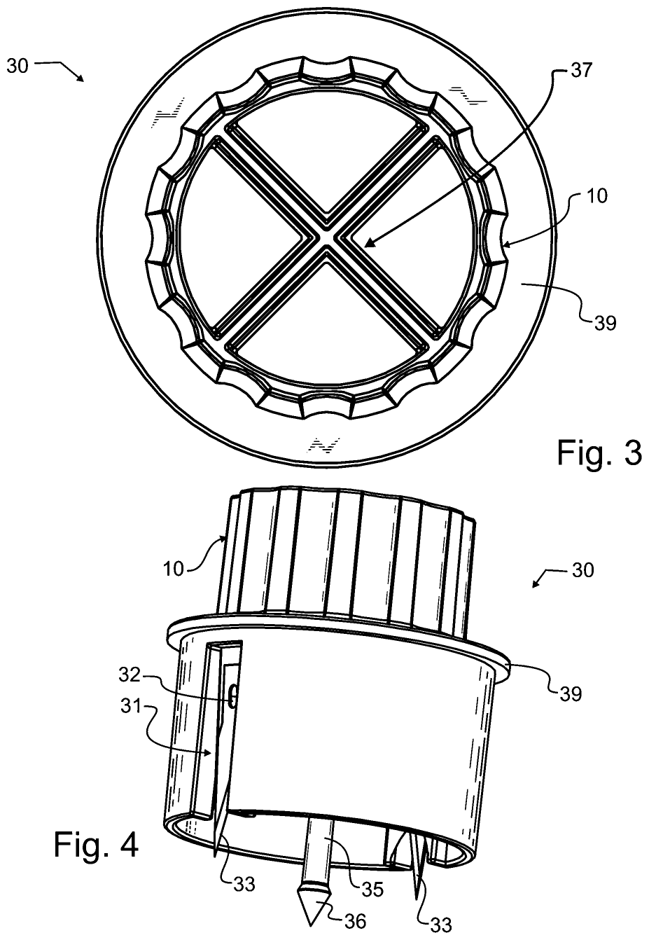

FIGS. 2-4 illustrate preferred embodiment foil cutter assembly 30 in greater detail, much of which is not visible or only partially visible in FIG. 1. Foil cutter assembly 30 is preferably provided with at least one cutter, and may be provided with more cutters as desired or selected by a designer. In preferred embodiment foil cutter 1, a pair of cutting blades 33 are provided at opposed locations on foil cutter assembly 30, approximately at 180 degree spacing. For each cutting blade 33, foil cutter assembly 30 has a cutting blade retainer 31 that has a geometry suitable to retain a cutting blade 33 therein. As best illustrated in FIG. 4, preferred embodiment foil cutter 1 has a rectangular opening that defines cutting blade retainer 31 into which cutting blade 33 is pressed. Optionally, a cutting blade detent 32 or the like may be provided that further engages with and locates cutting blade 33. As again best evident from FIG. 4, cutting blades 33 protrude beyond (below in the illustration) the main body of foil cutter assembly 30.

Defining a longitudinal center axis is a foil centering post 35 that terminates at a foil retaining bulb 36. Foil retaining bulb 36 preferably has a geometry designed to pierce a prior art container seal 4 without generating loose fragments. As illustrated, a geometry resembling that of a field arrowhead is preferred, though in alternative embodiments other geometries will be used. Once pierced, foil centering post 35 will preferably hold one or more such prior art container seals 4, thereby ensuring that such seals do not accidentally drop into the container or onto the ground. A post holding cross 37 spans generally radially from the outer perimeter of foil cutter assembly 30 to the longitudinal center axis, and provides the needed mechanical support for foil centering post 35 and foil retaining bulb 36.

As best understood from a comparison between FIG. 4 and FIG. 1, a sleeve stop 39 is preferably provided to engage with the end of container engaging sleeve 20 that is distal to container top receiving cavity 23, thereby locating container engaging sleeve 20 in proper position when installed about foil cutter assembly 30. This locating in proper position ensures the intended safe recessing of cutting blade 33 within container engaging sleeve 20. While not critical to the present invention, such engagement of sleeve stop 39 with the end of container engaging sleeve 20 can include affixing in any suitable manner, for exemplary and non-limiting purpose including a simple friction fit, ultrasonic welding, gluing, pinning, heat staking, or any other of the myriad of known affixing techniques.

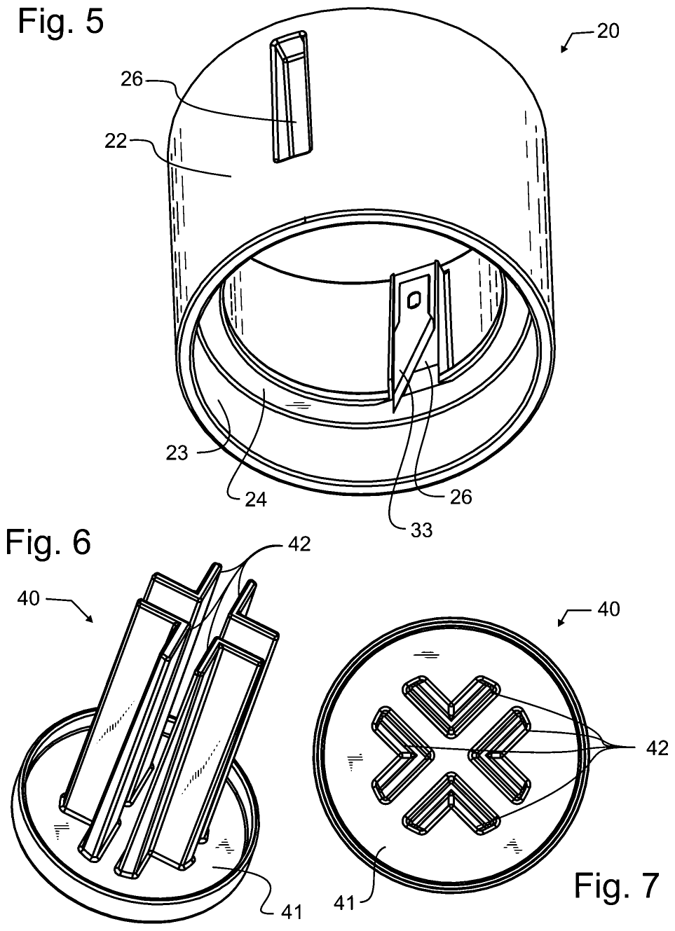

FIG. 5 illustrates preferred embodiment container engaging sleeve 20 separately, but with one cutting blade 33 shown strictly for purposes of illustration. While each of the components of container engaging sleeve 20 have already been described herein above with reference to FIG. 1, it is of particular note that cutting blade retainer 31 and blade retaining indent 26 are configured to completely capture and retain a cutting blade 33 therein. An optional cutting blade detent may be provided on either one or both of cutting blade retainer 31 and blade retaining indent 26, and a blade can be engaged with, heat staked or otherwise affixed to either such a detent, some other equivalent or similar structure, or directly to either one or both of cutting blade retainer 31 and blade retaining indent 26.

Of particular note, container engaging sleeve 20 and foil cutter assembly 30 are preferably assembled around and capture cutting blade 33, without requiring or generating any loading forces, flexure, or stress within cutting blade 33. The insertion of foil cutter assembly 30 into container engaging sleeve 20 and subsequent affixing will in some embodiments be permanent. In other embodiments, the insertion and affixing are reversible, such as by friction fit, latches, pins, or other techniques as known generally in the mechanical arts. When the insertion and affixing are reversible, cutting blade(s) 33 may be field serviceable, allowing these blades to be replaced when desired or required.

During use, a person will first remove the removable cover from a container such as those illustrated and described in the prior art incorporated herein above by reference, thereby exposing the destructible and anti-tampering foil seal applied to the container. Next, the person will place container top receiving cavity 23 in circumscribing relationship about the container top, pressing foil retaining bulb 36 into and eventually piercing through the seal. The person will continue to press preferred embodiment foil cutter 1 down onto the top of the container, which will also cause the two cutting blades 33 to pierce the affixed seal. Finally, container engaging lip 24 will engage with the top of the affixed seal, whereupon no more movement of preferred embodiment foil cutter 1 down onto the top of the container is possible. Engaging container engaging lip 24 with the container seal and circumscribing the top of the container with container top receiving cavity 23 will precisely locate the container top and container seal relative to preferred embodiment foil cutter 1.

Next, the person will grasp handle 10. Depending upon the size and mass of the container and the preferences of the person using preferred embodiment foil cutter 1, the person may also elect to simultaneously grasp the container. The person will then generate a rotary motion of preferred embodiment foil cutter 1 about the longitudinal axis defined by foil centering post 35, preferably through enough of an arc to fully sever the foil seal. In preferred embodiment foil cutter 1 that incorporates a pair of blades each displaced from the other by 180 degrees about the foil cutter assembly 30, the arc required to fully sever the foil seal is an at least a 180 degree arc. This will cause cutting blades 33 to sever the container seal just inside of the container opening.

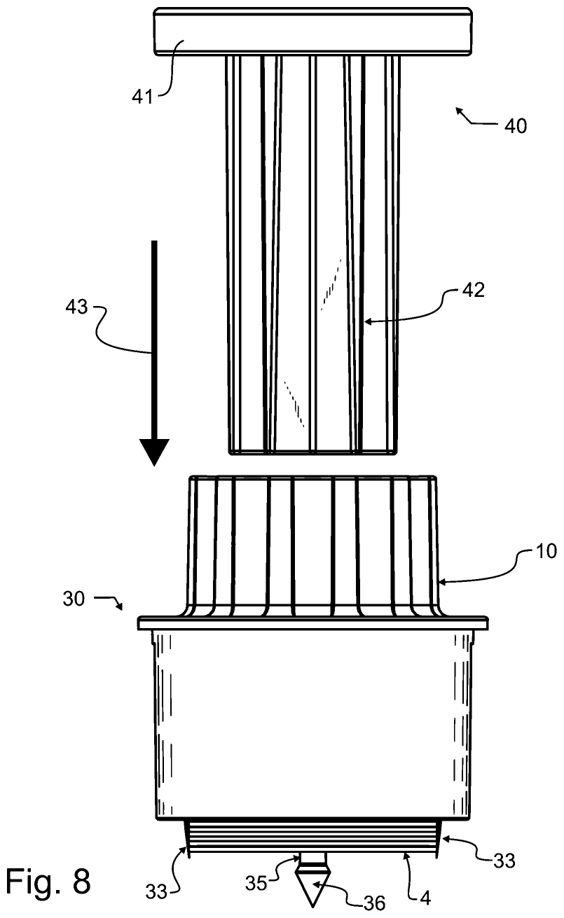

Once fully severed, the container seal 4 will be retained upon foil centering post 35 as illustrated for exemplary purposes in FIG. 8, being prevented from discharge by the geometry of foil retaining bulb 36. This helps to ensure that such seals do not accidentally drop into the container or onto the ground. This inherent retention of the foil seal is particularly valuable where the contents of the container are hazardous, messy, or the like.

At some time after one or more container seals 4 have accumulated about foil centering post 35, it will be desirable to remove them therefrom. While wire, nails, or the like could be inserted into an opening between the arms of post holding cross 37, FIGS. 6 and 7 illustrate a preferred embodiment seal pusher that may optionally be used in combination with preferred embodiment foil cutter 1. Seal pusher 40 has a plunger hand grip and stop 41 that can be manually grasped and manipulated, and foil pushing cross 42 rises from plunger hand grip and stop 41. Preferably, for each opening within post holding cross 37, one member of foil pushing cross 42 will be provided and located so as to pass within that opening within post holding cross 37. Since post holding cross 37 as illustrated has four such openings, foil pushing cross 42 similarly has four protrusions rising from plunger hand grip and stop 41. Also as illustrated, each member of foil pushing cross 42 is defined by an “angle iron” geometry which provides ample strength and rigidity, but in alternative embodiments other geometries will be provided.

FIG. 8 illustrates preferred embodiment seal pusher being used in combination with preferred embodiment foil cutter 1, with container engaging sleeve 20 removed only for purposes of illustration. One or more cut foils 4 have accumulated about foil centering post 35. To remove them therefrom, a person will slide seal pusher 40 into preferred embodiment foil cutter 1, with each member of foil pushing cross 42 passing through an opening in post holding cross 37. As seal pusher 40 is moved in the direction indicated by arrow 43, end eventually stopped by the engagement between plunger hand grip and stop 41 and handle 10, foil pushing cross 42 will drive the accumulated cut foils 4 off of foil centering post 35. According to one preferred method, this may be done while preferred embodiment foil cutter 1 is engaged with an open and emptied container. By doing so, the cut foils 4 will be driven into the empty container for proper disposal, without having to be handled at all by a person.

Various embodiments of apparatus designed in accord with the present invention have been illustrated in the various figures. The embodiments are distinguished by the hundreds digit, and various components within each embodiment designated by the ones and tens digits. However, many of the components are alike or similar between embodiments, so numbering of the ones and tens digits have been maintained wherever possible, such that identical, like or similar functions may more readily be identified between the embodiments. If not otherwise expressed, those skilled in the art will readily recognize the similarities and understand that in many cases like numbered ones and tens digit components may be substituted from one embodiment to another in accord with the present teachings, except where such substitution would otherwise destroy operation of the embodiment. Consequently, those skilled in the art will readily determine the function and operation of many of the components illustrated herein without unnecessary additional description.

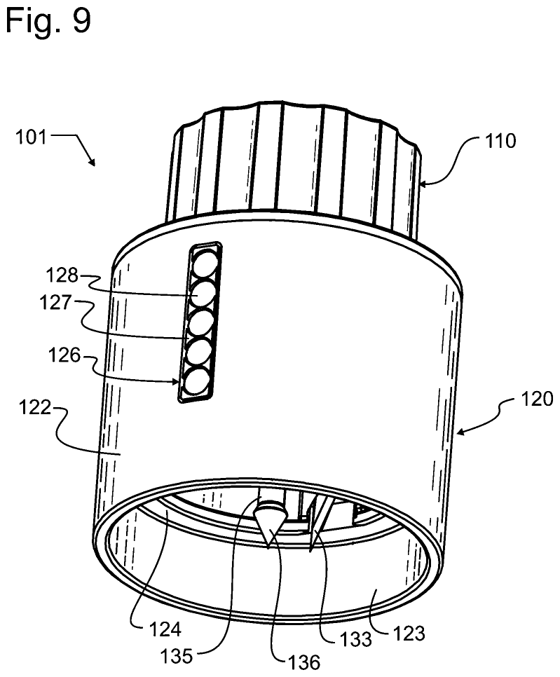

FIG. 9 illustrates a first alternative embodiment foil cutter designed in accord with the teachings of the present invention from a front and slightly projected view. While nearly all of the components are like or identical to those illustrated in FIGS. 1-8, in alternative embodiment foil cutter 101 a magnet holder 127 is provided within blade retaining indent 126. At least one magnet 128, and as illustrated a total of five magnets, are held within magnet holder 127. These magnets 128 are provided in this alternative embodiment to either solely or additionally further engage and hold a cutting blade 133 within cutting blade retainer 131 and blade retaining indent 126. When so provided, assembly and disassembly of container engaging sleeve 20 from foil cutter assembly 30 is also facilitated, without the fear of dropping or losing a cutting blade 33. As may be apparent, in other alternative embodiments other known blade retention apparatus and fasteners known from the mechanical arts are provided instead of or in addition to the magnets and detents illustrated and described herein.

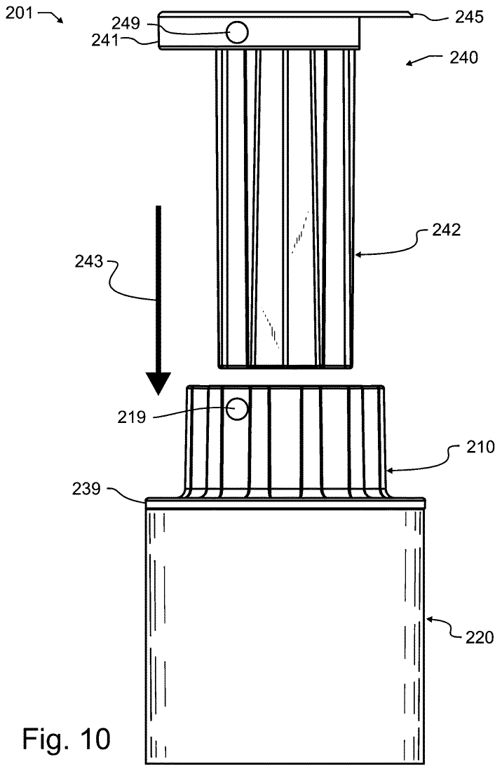

FIG. 10 illustrates a second alternative embodiment foil cutter 201. This illustration, like that of FIG. 8, is shown from a side elevational view. However, and different from FIG. 8, in FIG. 10 the container engaging sleeve 220 is illustrated as well, thereby concealing nearly all of foil cutter assembly 230. The only component of foil cutter assembly 230 that is visible in FIG. 10 is the sleeve stop 239. This means that FIG. 10 illustrates the second alternative embodiment foil cutter 201 exactly as it would look in actual use from this viewing direction.

The features of second alternative embodiment foil cutter 201 that differ from preferred embodiment foil cutter 1 are the hanging hole 219 passing through handle 210, hanging hole 249 passing though plunger hand grip and stop 241, and tape cutter 245. Tape cutter 245 in second alternative embodiment foil cutter 201 comprises a portion of plunger hand grip and stop 241 that is not provided with an additional skirt, and which in some embodiments is further provided with a beveled or ground edge. This allows tape cutter 245 to be used as an easily accessible cutter to break shrink wrap seals and tape seals that are sometimes found on containers, and to provide other similar utility when needed. Hanging hole 219 provides a convenient point to tether or hang handle 210, which will thereby also tether or suspend container engaging sleeve 220 and foil cutter assembly 230. Hanging hole 249 provides a convenient point to tether or hang seal pusher 240.

While not separately illustrated, when seal pusher 240 is reversed relative to handle 210, container engaging sleeve 220, and foil cutter assembly 230, and then is pushed all the way into container engaging sleeve 220 in the direction opposite of arrow 243, foil pushing cross 242 will also insert entirely into container engaging sleeve 220. To facilitate convenient storage, small detents or bumps are preferably provided either in foil pushing cross 242 or plunger hand grip and stop 241 that will engage with components within any or all of handle 210, container engaging sleeve 220, and foil cutter assembly 230 to hold seal pusher 240 in place for storage. For exemplary and non-limiting purpose, small detents or bumps are provided in some embodiments on foil pushing cross 242 that will engage in gentle interference with post holding cross 237 when seal pusher 240 is pushed all the way into container engaging sleeve 220 in the direction opposite of arrow 243.

From the foregoing figures and description, several additional features and options become more apparent. First of all, foil cutter 1 may be manufactured from a variety of materials, including metals, resins and plastics, ceramics or cementitious materials, or even combinations or composites of the above. The specific material used may vary, though special benefits are attainable if several important factors are taken into consideration. First, by using partially resilient or elastomeric materials such as plastics and high durometer thermoplastic elastomers, cutting blade 30 can more readily be press fit. Furthermore, it is preferable that all materials are sufficiently tough and durable to not fracture, even when unexpected forces are applied.

While the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims herein below.

We claim:

1. In combination, a container and a foil cutter,
said container comprising:
a receptacle holding contents therein;
an opening extending between said receptacle and an exterior of said receptacle; and
an affixed foil seal closing said opening;
said foil cutter comprising:
a unitary container engaging sleeve having
an outer shell,
a container top receiving cavity encompassing said container opening and said affixed foil seal, and
a blade retainer defined on an interior of said outer shell;
a unitary foil cutter assembly having
a body defining an interior and an exterior, said body inserted within said outer shell,
a cutting blade retainer defined on an exterior of said body; and
a cutting blade retained between said cutting blade retainer and said container engaging sleeve blade retainer, said cutting blade piercing said affixed foil seal.

2. The combination container and foil cutter of claim 1, wherein said container top receiving cavity defines a bottle top receiving opening.

3. The combination container and foil cutter of claim 2, wherein said container top receiving cavity is cylindrical.

4. The combination container and foil cutter of claim 1, wherein said unitary container engaging sleeve further comprises a container engaging lip having an interior diameter smaller than a diameter of said container top receiving cavity.

5. The combination container and foil cutter of claim 4, wherein said container engaging lip is in contact with said affixed foil seal.

6. The combination container and foil cutter of claim 1, wherein said container engaging sleeve blade retainer comprises an indent in said outer shell.

7. The combination container and foil cutter of claim 6, wherein said cutting blade further comprises an aperture, and wherein said container engaging sleeve blade retainer further comprises a blade detent extending at least partially into an aperture in said cutting blade.

8. The combination container and foil cutter of claim 1, wherein said cutting blade further comprises an aperture, and wherein said foil cutter assembly cutting blade retainer further comprises a cutting blade detent extending at least partially into an aperture in said cutting blade.

9. The combination container and foil cutter of claim 1, wherein said foil cutter assembly further comprises a sleeve stop engaging and affixed with a first longitudinal end of said outer shell.

10. The combination container and foil cutter of claim 1, wherein said foil cutter assembly further comprises:
a foil centering post,
a foil retaining bulb, and
a cross suspending said foil centering post along a longitudinal axis of said foil cutter assembly.

11. The combination container and foil cutter of claim 10, further comprising a seal pusher having a plunger hand grip and stop, and a foil pushing cross extending from said plunger hand grip and stop.

12. The combination container and foil cutter of claim 11,
wherein said cross defines four distinct openings, and
wherein said foil pushing cross comprises four protrusions extending from said plunger hand grip and stop, each one of said foil pushing cross comprises four protrusions configured to pass through a unique one of said cross four distinct openings.

13. In combination, a container and a foil cutter,
said container comprising:
a receptacle holding contents therein;
an opening extending between said receptacle and an exterior of said receptacle; and
an affixed foil seal closing said opening;
said foil cutter comprising:
a unitary container engaging sleeve having
a cylindrical outer shell,
a cylindrical container top receiving cavity defines a bottle top receiving opening encompassing said container opening and said affixed foil seal,
a container engaging lip having an interior diameter smaller than a diameter of said container top receiving cavity, said container engaging lip in contact with said affixed foil seal, and
a blade retainer defined on an interior of said outer shell;
a unitary foil cutter assembly having
a body defining an interior and an exterior, said body inserted within said outer shell,
a sleeve stop terminating said body and engaging and affixed with a first longitudinal end of said cylindrical outer shell,
a cutting blade retainer defined on an exterior of said body; and
a cutting blade retained between said cutting blade retainer and said container engaging sleeve blade retainer, said cutting blade piercing said affixed foil seal.

14. A foil cutter, comprising:
a container engaging sleeve having
an outer shell,
a container opening receiving cavity configured to encompass a container opening having an affixed foil seal,
a container engaging lip having an interior opening smaller than an interior opening of said container top receiving cavity, said container engaging lip configured to contact with said affixed foil seal, and
a blade retainer defined on an interior of said outer shell;
a foil cutter assembly having
a body defining an interior and an exterior, said body inserted within said outer shell,
a cutting blade retainer defined on an exterior of said body; and
a cutting blade retained between said cutting blade retainer and said container engaging sleeve blade retainer, said cutting blade configured to pierce said affixed foil seal.

15. The foil cutter of claim 14, wherein said unitary foil cutter assembly further comprises a sleeve stop terminating said body and engaging and affixed with a first longitudinal end of said outer shell.

16. The foil cutter of claim 14, wherein said outer shell further comprises a cylinder.

17. The foil cutter of claim 16, wherein said unitary foil cutter assembly further comprises a cylinder.

18. The foil cutter of claim 17, wherein said foil cutter assembly further comprises a sleeve stop terminating said body, said sleeve stop having an outside diameter greater than an interior diameter of said cylindrical outer shell, said sleeve stop engaging and affixed with a first longitudinal end of said outer shell.

19. The foil cutter of claim 14, wherein said container engaging sleeve is unitary.

20. The foil cutter of claim 19, wherein said foil cutter assembly is unitary.
